(19) United States
(12) Patent Application Publication
(10) Pub. No.: US 2012/0281977 A1
(43) Pub. Date: Nov. 8, 2012

(54) CAMERA LENS CAP HOLDER

(76) Inventor: Mark David Stevenson, Lombard, IL (US)

(21) Appl. No.: 13/450,418

(22) Filed: Apr. 18, 2012

Related U.S. Application Data
(60) Provisional application No. 61/481,349, filed on May 2, 2011.

(51) Int. Cl. G03B 17/56

(52) U.S. Cl. 396/544

(57) ABSTRACT

A lens cap holder securely fastens a camera lens cap to the camera's neck strap, a general strap, or other desired article. The camera lens cap holder can be threaded onto the camera neck strap, other general strap, or the like, through openings in the body of the lens cap holder. Alternatively, a lanyard may be attached to the lens cap holder and securely affixed to an article of choice, including the camera body. The body of the lens cap holder includes a recess approximately the size of a lens cap. The lens cap can mount in the recess by means of a friction fit, similar to the lens cap retaining arrangement of the camera lens. The lens cap holder does not require any alteration of the lens cap or camera. Being of single piece construction, the lens cap holder is relatively low cost as compared to current solutions.

### CROSS-REFERENCE TO RELATED APPLICATIONS

This application claims the benefit of priority of U.S. provisional patent application number 61/481,349, filed May 2, 2011, the contents of which are herein incorporated by reference.

### BACKGROUND OF THE INVENTION

The present invention relates to camera accessories and, more particularly, to a threaded holder with a strap connector for retaining a camera lens cap.

Camera lens caps are commonly mounted to a camera to protect the lens. These lens caps are removed while the camera is in use. A problem with such devices is that they are relatively expensive and easy to lose or misplace when the camera is being used.

Current solutions for retaining camera lens caps require modification of the lens cap or applying glue to the lens cap. This alteration to the original liens cap is undesirable.

Another solution is to connect the lens cap to an elastic strap having a loop mounted around the lens housing or attached to the camera body. The cap hangs below the camera and may interfere with its use. This solution removes the lens cap from the general camera use area.

As can be seen, there is a need for camera lens cap holder that can keep the lens cap immediately accessible while the cap is off the camera lens.

### SUMMARY OF THE INVENTION

In one aspect of the present invention, a lens cap holder comprises a center body having a recess sized to accommodate a lens cap; an opening formed on an outer periphery of the center body, the opening disposed on at least one side of the center body; and a hole in the center body.

In another aspect of the present invention, a lens cap holder comprises a center body having a recess sized to accommodate a lens cap; and an opening formed on an outer periphery of the center body, the opening disposed on at least one side of the center body, wherein the opening is adapted to be positioned along a strap to secure the lens cap holder thereto.

In a further aspect of the present invention, a lens cap holder comprises a center body; a recess formed in the center body, the recess adapted to retain a lens cap therein; an opening disposed on each side of the center body, the opening adapted to permit a strap to be threaded therethrough; and a hole disposed in the center body.

These and other features, aspects and advantages of the present invention will become better understood with reference to the following drawings, description and claims.

### BRIEF DESCRIPTION OF THE DRAWINGS

FIG. 1 is an inside perspective view of a lens cap holder according to an exemplary embodiment of the present invention;

FIG. 2 is an outside perspective view of the lens cap holder of FIG. 1;

FIG. 3 is a perspective view of the lens cap holder of FIG. 1, showing the attachment of a lens cap thereto;

FIG. 4 is a perspective view of a lens cap holder according to an alternate embodiment of the present invention; and

FIG. 5 is a perspective view of the lens cap holder of FIG. 4, showing attachment of a lens cap thereto.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a lens cap holder that securely fastens a camera lens cap to the camera's neck strap, a general strap, or any other article of choice. The camera lens cap holder can be threaded onto the camera neck strap, other general strap, or the like, through openings in the body of the lens cap holder. Alternatively, a lanyard may be attached to the lens cap holder and securely affixed to an article of choice, including the camera body. The body of the lens cap holder includes a recess approximately the size of a lens cap. The lens cap can mount in the recess by means of a friction fit, similar to the lens cap retaining arrangement of the camera lens. The lens cap holder of the present invention does not require any alteration of the lens cap or camera. Being of single piece construction, the lens cap holder is relatively low cost as compared to current solutions.

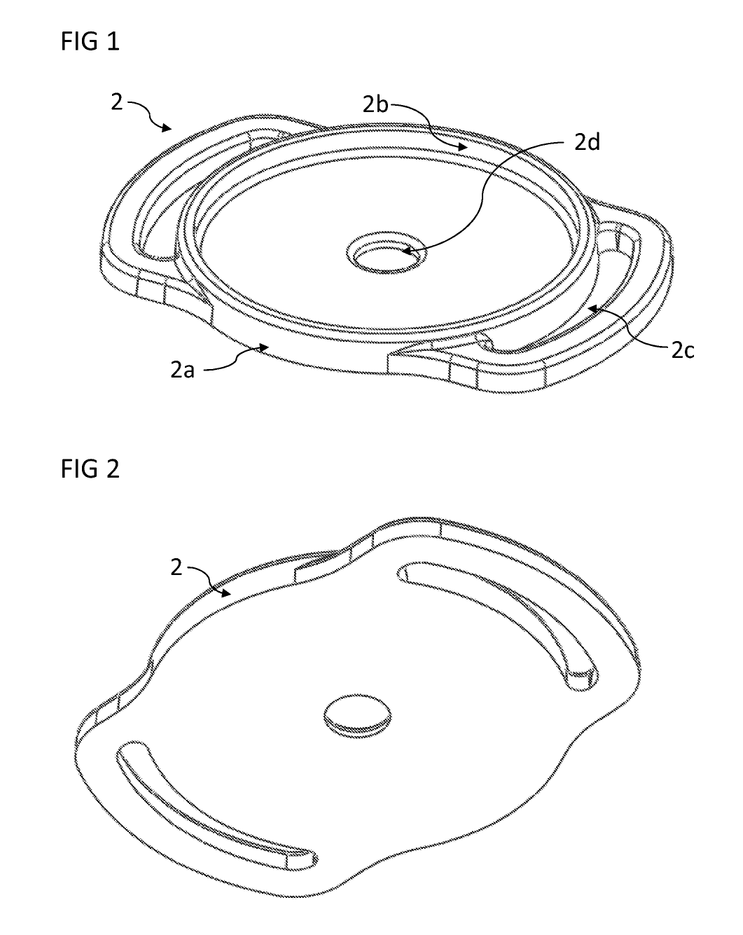

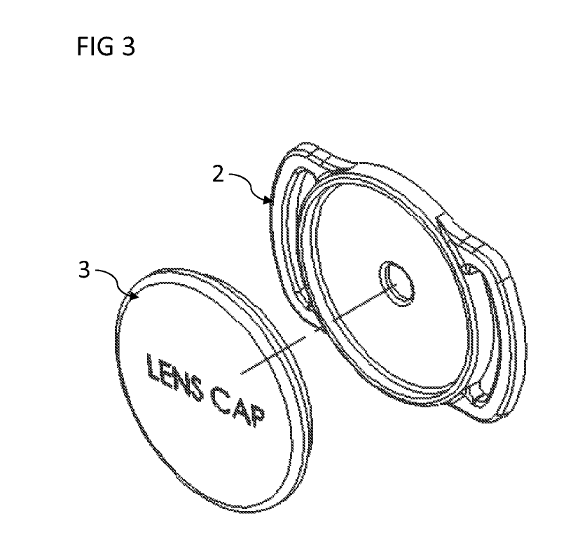

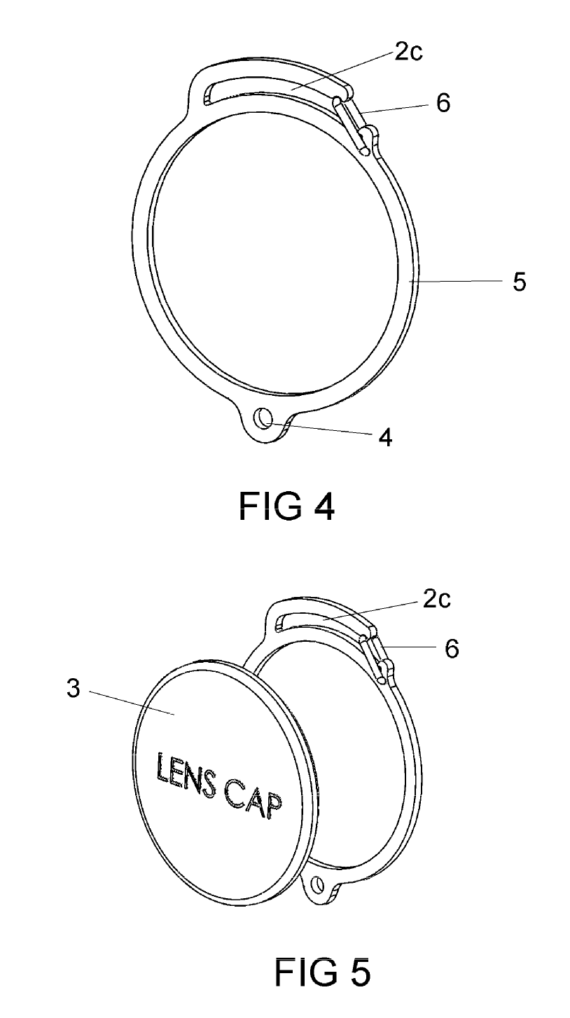

Referring now to FIGS. 1 through 3, a lens cap holder 2 may have a center body 2a with a recess or hole 2b sized to accommodate a lens cap 3. The recess 2b may optionally include threading or an undercut for better retention of the camera lens cap 3. An optional drainage hole 2d can allow air to escape when the lens cap 3 is placed into the recess 2b and can also allow water or debris to escape the lens cap holder 2 when the lens cap 3 is affixed thereto. Optional openings 2c on sides of the lens cap holder 2 allow threading the lens cap holder 2 onto the camera neck strap, for example. A hole 4, see FIG. 4, in the lens cap holder 2 may allow a lanyard, ring or carabineer to be attached to the lens cap holder 2 for additional attachment options.

Referring to FIGS. 4 and 5, a lens cap holder 5 may include a clip 6 to permit access to the opening 2c of the lens cap holder 5. The clip 6 may allow attachment of the lens cap holder 5 without the need to fully thread the lens cap holder 5 onto a strap.

The lens cap holder 2, 5 of the present invention may be machined from various materials, including plastics, aluminum and steel, for example. Alternatively, the lens cap holder 2, 5 may be injected molded in various materials, including plastics. Alternatively, the lens cap holder 2, 5 may be die-cast or forged in a variety of materials, including steel and aluminum.

The lens cap holder 2, 5 of the present invention could also be designed to hold camera lens filters, such as UV or polarized filters.

It should be understood, of course, that the foregoing relates to exemplary embodiments of the invention and that modifications may be made without departing from the spirit and scope of the invention as set forth in the following claims.

What is claimed is:

1. A lens cap holder comprising:
a center body having a recess sized to accommodate a lens cap; and
an opening formed on an outer periphery of the center body, the opening disposed on at least one side of the center body.

2. The lens cap holder of claim 1 further comprising a hole in the center body.

3. The lens cap holder of claim 1, further comprising threads or undercuts disposed along an inside periphery of the recess, the threads or undercuts adapted to improve retention of the lens cap in the recess.

4. The lens cap holder of claim 1, further comprising at least one clip opening and closing access to the opening.

5. The lens cap holder of claim 1, further comprising a first opening and a second opening disposed on opposite sides of the center body.

6. A lens cap holder comprising:
a center body having a recess sized to accommodate a lens cap; and
an opening formed on an outer periphery of the center body, the opening disposed on at least one side of the center body, wherein the opening is adapted to be positioned along a strap to secure the lens cap holder thereto.

7. The lens cap holder of claim 6, further comprising threads or undercuts disposed along an inside periphery of the recess, the threads or undercuts adapted to improve retention of the lens cap in the recess.

8. The lens cap holder of claim 6, further comprising at least one clip opening and closing access to the opening.

9. The lens cap holder of claim 6, further comprising a first opening and a second opening disposed on opposite sides of the center body.

10. A lens cap holder comprising:
a center body;
a recess formed in the center body, the recess adapted to retain a lens cap therein; and
an opening disposed on each side of the center body.

11. The lens cap holder of claim 10, further comprising a hole disposed in the center body.

12. The lens cap holder of claim 10, further comprising at least one clip opening and closing access to the opening.
